(19) United States
(12) Patent Application Publication
(10) Pub. No.: US 2019/0304327 A1
(43) Pub. Date: Oct. 3, 2019

(54) SINGING PRACTICE DEVICE, SINGING PRACTICE METHOD, AND STORAGE MEDIUM

(71) Applicant: CASIO COMPUTER CO., LTD., Tokyo (JP)

(72) Inventor: Masaru SETOGUCHI, Tokyo (JP)

(73) Assignee: CASIO COMPUTER CO., LTD., Tokyo (JP)

(21) Appl. No.: 16/365,480

(22) Filed: Mar. 26, 2019

(30) Foreign Application Priority Data
Mar. 27, 2018 (JP) 2018-059272

(51) Int. Cl. G09B 15/00; G09B 19/00; G10L 25/90

(52) U.S. Cl. CPC G09B 15/00; G10L 25/90; G09B 19/00

(57) ABSTRACT

A singing practice device includes a memory having stored thereon a musical piece data of a musical piece that includes an accompaniment and a vocal part to be sung by a user and at least one processor, wherein when a first segment of the vocal part to be sung by the user during a first time interval arrives while the accompaniment is being played back, the at least one processor determines whether an utterance is input by the user through an audio input device during the first time interval and causes the accompaniment to continue being played back until a point in time immediately before the next time interval only when the utterance was input by the user during the first time interval.

### BACKGROUND OF THE INVENTION

### Technical Field

The present disclosure relates to a singing practice device, a singing practice method, and a storage medium.

### Background Art

A technology is known in which a microphone is set to an on state in periods when singing should be performed and is set to an off state in the other periods.

Patent Document 1: Japanese Patent Application Laid-Open Publication No. 2003-177769

However, with the above-cited technology of the related art, it is difficult to support the user such that the user develops a singing ability that enables the user to sing with correct pitch and correct vocalizations (lyrics) as well as with correct vocalization timing.

One advantage of the present invention is that a singing practice device can be provided that can support a user such that the user acquires a singing ability enabling the user to sing with correct pitch or correct vocalization as well as with correct vocalization timing.

### SUMMARY OF THE INVENTION

Accordingly, the present invention is directed to a scheme that substantially obviates one or more of the problems due to limitations and disadvantages of the related art.

Additional or separate features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides a singing practice device including: a memory having stored thereon a musical piece data of a musical piece that includes accompaniment data for an accompaniment and vocal data for a vocal part to be sung by a user, the vocal part including at least a first segment to be sung by the user during a first time interval while the accompaniment is being played back and a second segment to be sung by the user during a second time interval that follows the first time interval while the accompaniment is being played back; at least one processor; an audio input device to receive vocal input by the user; and an audio output device to audibly output sound to the user, wherein the at least one processor performs the following: causing the accompaniment to be played back from the audio output device in accordance with the accompaniment data; when the first time interval arrives while the accompaniment is being played back, determining whether an utterance is input by the user through the audio input device during the first time interval; causing the accompaniment to continue being played back until a point in time immediately before the second time interval only when the utterance was input by the user during the first time interval; and causing the accompaniment to stop being played back when the utterance was not input by the user during the first time interval.

In another aspect, the present disclosure provides a method to be executed by at least one processor in a singing practice device that includes: a memory having stored thereon a musical piece data of a musical piece that includes accompaniment data for an accompaniment and vocal data for a vocal part to be sung by a user, the vocal part including at least a first segment to be sung by the user during a first time interval while the accompaniment is being played back and a second segment to be sung by the user during a second time interval that follows the first time interval while the accompaniment is being played back; at least one processor; an audio input device to receive vocal input by the user; and an audio output device to audibly output sound to the user, method including, via the at least one processor: causing the accompaniment to be played back from the audio output device in accordance with the accompaniment data; when the first time interval arrives while the accompaniment is being played back, determining whether an utterance is input by the user through the audio input device during the first time interval; causing the accompaniment to continue being played back until a point in time immediately before the second time interval only when the utterance is input by the user during the first time interval; and causing the accompaniment to stop being played back when the utterance was not input by the user during the first time interval.

In another aspect, the present disclosure provides a non-transitory computer-readable storage medium having stored thereon a program executable by at least one processor in that causes a singing practice device that includes, in addition to the at least one processor: a memory having stored thereon a musical piece data of a musical piece that includes accompaniment data for an accompaniment and vocal data for a vocal part to be sung by a user, the vocal part including at least a first segment to be sung by the user during a first time interval while the accompaniment is being played back and a second segment to be sung by the user during a second time interval that follows the first time interval while the accompaniment is being played back; an audio input device to receive vocal input by the user; and an audio output device to audibly output sound to the user, method including, via the at least one processor, the program causing the at least one processor to perform the following: causing the accompaniment to be played back from the audio output device in accordance with the accompaniment data; when the first time interval arrives while the accompaniment is being played back, determining whether an utterance is input by the user through the audio input device during the first time interval; causing the accompaniment to continue being played back until a point in time immediately before the second time interval only when the utterance is input by the user during the first time interval; and causing the accompaniment to stop being played back when the utterance was not input by the user during the first time interval.

It is to be understood that both the foregoing general description and the following detailed description are exemplary and explanatory, and are intended to provide further explanation of the invention as claimed.

### BRIEF DESCRIPTION OF THE DRAWINGS

The present invention will be more understood with reference to the following detailed descriptions with the accompanying drawings.

FIG. 1 is an external view schematically illustrating a singing practice device according to an embodiment of the present invention.

FIG. 2 is a schematic diagram illustrating the hardware configuration of a control system of the singing practice device.

FIG. 3 is a diagram illustrating an example of modes that can be implemented by the singing practice device.

FIG. 4 is a block diagram illustrating an example of functions of the singing practice device.

FIG. 5 is an outline flowchart illustrating an example of processing executed by the singing practice device in a vocalization timing learning mode.

FIG. 6A is an explanatory diagram for FIG. 5 and illustrates a case where an accompaniment advances.

FIG. 6B is an explanatory diagram for FIG. 5 and illustrates a case where the accompaniment is stopped.

FIG. 7 is an outline flowchart illustrating an example of processing executed by the singing practice device in a correct vocalization learning mode.

FIG. 8A is a diagram that is an explanatory diagram for FIG. 7 and illustrates a case where an accompaniment advances.

FIG. 8B is an explanatory diagram for FIG. 7 and illustrates a case where the accompaniment is stopped.

FIG. 9 is an outline flowchart illustrating an example of processing executed by the singing practice device in a correct vocalization and correct pitch learning mode.

FIG. 10A is an explanatory diagram for FIG. 9 and illustrates a case where an accompaniment advances.

FIG. 10B is an explanatory diagram for FIG. 9 and illustrates a case where the accompaniment is stopped.

### DETAILED DESCRIPTION OF EMBODIMENTS

Hereafter, an embodiment will be described in detail while referring to the accompanying drawings.

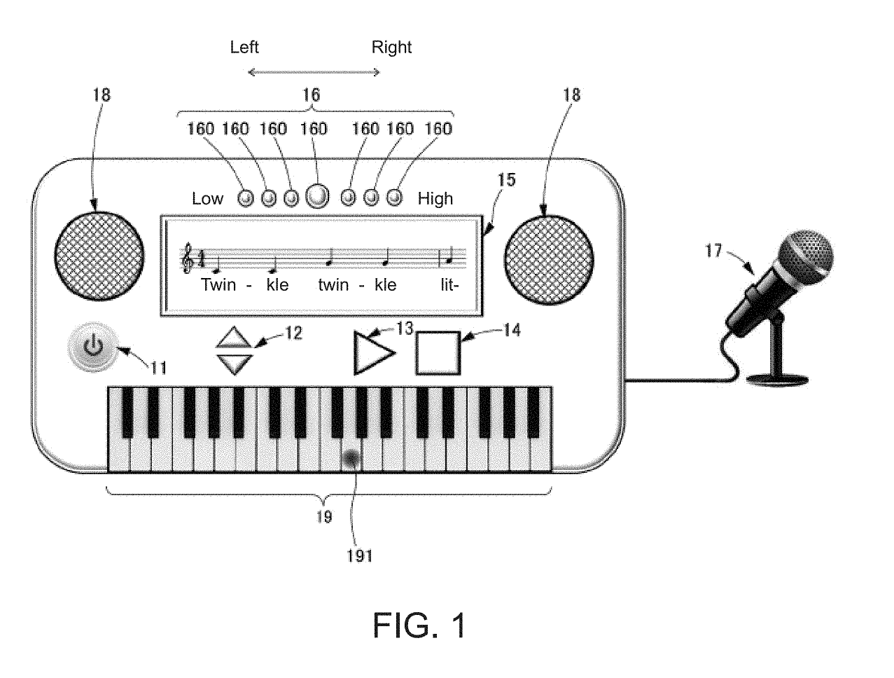

FIG. 1 is an external view schematically illustrating a singing practice device 1 according to an embodiment of the present invention.

The singing practice device 1 includes a power button 11, musical piece selection buttons 12, a play button 13, a stop button 14, and so on as a user interface. The singing practice device 1 further includes a display unit 15, a guidance unit 16, speakers 18, and so on. Furthermore, a microphone 17 can be connected the singing practice device 1.

The power button 11 is a button that the user can operate in order to switch the singing practice device 1 on and off.

The musical piece selection buttons 12 are buttons that the user can operate in order to select a musical piece to be played by the singing practice device 1.

The play button 13 is a button that can be operated by the user in order to play a musical piece or the like.

The stop button 14 is a button that can be operated by the user in order to stop playing of a musical piece or the like.

The display unit 15 is, for example, a liquid crystal display, and for example, as illustrated in FIG. 1 outputs part of the musical score, part of the lyrics, and so on of a musical piece currently being played.

The guidance unit 16 has a pitch display function for displaying the pitch of a vocalization (i.e., the user utterance) with respect to the correct pitch. In this embodiment, as an example, the guidance unit 16 includes a plurality of lamps 160. The lamps 160 are light-emitting diodes (LEDs), for example. A state in which the center lamp 160 is lit up corresponds to a state in which the pitch of the vocalization matches the correct pitch. On the other hand, a state in which a lamp 160 to the right of the center is lit up corresponds to a state in which the pitch of the vocalization is higher than the correct pitch. As the pitch of the vocalization becomes increasingly higher relative to the correct pitch, a lamp 160 disposed increasingly further toward the right side is lit up. A state in which a lamp 160 to the left of the center is lit up corresponds to a state in which the pitch of the vocalization is lower than the correct pitch. As the pitch of vocalization becomes increasingly lower relative to the correct pitch, a lamp 160 disposed increasingly further toward the left side is lit up.

The guidance unit 16 may further have a vocalization display function that displays information indicating whether the vocalization matches the correct lyric. For example, a state in which all of the lamps 160 of the guidance unit 16 are lit up may correspond to a state in which the vocalization matches the correct lyric. Alternatively, all of the lamps 160 of the guidance unit 16 may flash a prescribed number of times when the vocalization matches the correct lyric.

In the case where the guidance unit 16 has the vocalization display function in addition to the pitch display function, there is an advantage in that a simpler configuration can be realized compared with the case where a separate guidance unit is provided for realizing the vocalization display function. A separate guidance unit for realizing the vocalization display function may be provided by making the text that is to be highlighted on the display unit 15 be colored with a prescribed color, lit up, or flash when the vocalization matches the correct lyric, for example. Since the separate guidance unit is realized by the display unit 15, there is an advantage in that a simple configuration can be realized in this case as well. Alternatively, a separate guidance unit for realizing the vocalization display function may be realized by a dedicated guidance unit rather than the guidance unit 16 or the display unit 15.

The microphone 17 is preferably a unidirectional microphone. The directivity of the microphone 17 is set so as to be in the vicinity of the user's mouth, and as a result it is easy to extract just the vocalizations of the user from among the various sounds acquired via the microphone 17. However, the microphone 17 does not have to be unidirectional. In such a case, other sounds picked up by the microphone 17 (sounds other than vocalizations such as an accompaniment) may be removed by performing signal processing.

A musical piece accompaniment, vocalizations of the user, and so on are output from the speakers 18.

In the example illustrated in FIG. 1, the singing practice device 1 further includes an optical keyboard 19. In other words, the singing practice device 1 can also function as an electronic keyboard. In FIG. 1, a “G” key is highlighted (refer to location indicated by symbol 191), and thus it is indicated that the timing at which the key corresponding to “G” is to be played comes next. In addition, as a modification, the optical keyboard 19 may be omitted.

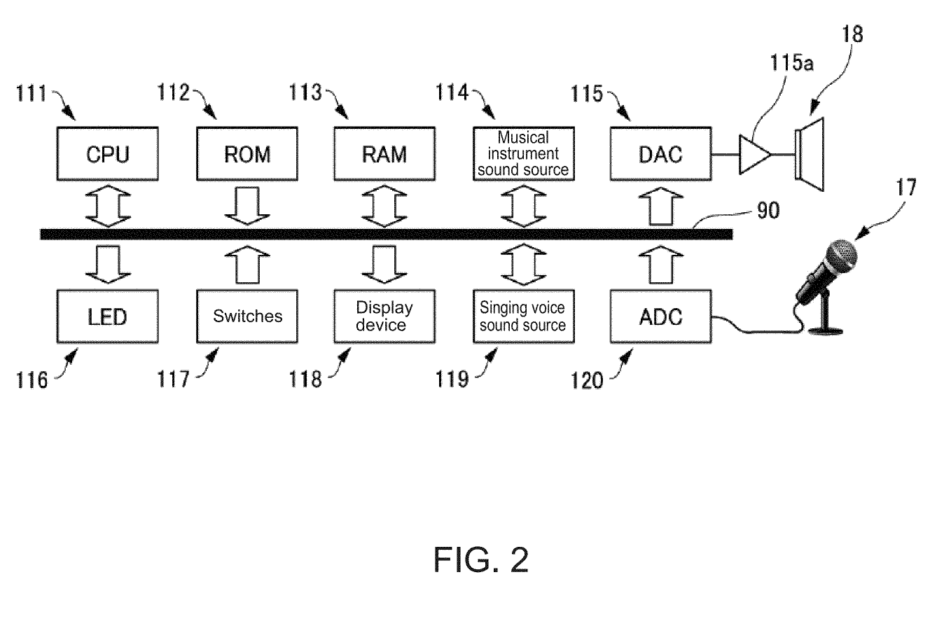

FIG. 2 is a schematic diagram illustrating the hardware configuration of a control system of the singing practice device 1.

The singing practice device 1 includes a central processing unit (CPU) 111, a read only memory (ROM) 112, a random access memory (RAM) 113, a musical instrument sound source 114, a digital-to-analog converter (DAC) 115, LEDs 116, switches 117, a display device 118, a singing voice sound source 119, and an analog-to-digital (ADC) converter 120, which are connected to one another via a bus 90.

The CPU 111 controls operation of the entire singing practice device 1. The CPU 111 reads a specified program from the ROM 112, loads the program into the RAM 113, and executes various processing in cooperation with the loaded program.

The ROM 112 is a read-only storage unit and stores programs, tone color waveform data, musical instrument digital interface (MIDI) data, various parameters, and so forth. In addition, musical piece data (MIDI data) does not have to be acquired from the ROM 112 and for example may instead be acquired from a USB memory or an external terminal (device other than singing practice device 1) or may be acquired via a network.

The RAM 113 is a readable/writeable storage unit and temporarily stores data and the like that are required in the processing executed by the CPU 111.

The musical instrument sound source 114 generates musical sounds based on musical instrument sounds. For example, the musical instrument sound source 114 generates musical sounds in accordance with a musical sound generation instruction from the CPU 111 and outputs a musical sound signal to the DAC 115.

The DAC 115 converts a digital signal (for example, a musical sound signal relating to digital musical sounds or a singing voice signal, which will be described later) into an analog signal. The analog signal obtained through this conversion is amplified by an amplifier 115a and the resulting signal is then output via the speakers 18.

The LEDs 116 form the lamps 160 of the guidance unit 16.

The switches 117 form various buttons such as the musical piece selection buttons 12.

The display device 118 forms the display unit 15.

The singing voice sound source 119 is a vocal sound source that generates a singing voice. For example, the singing voice sound source 119 is an engine in which a voice synthesizing method based on the hidden Markov model is employed to synthesize a singing voice. The hidden Markov model is widely used in voice recognition and so forth as a method of modeling feature parameter sequences of a voice. For example, the singing voice sound source 119 generates a singing voice in accordance with a singing voice generation instruction from the CPU 111 and outputs a singing voice signal to the DAC 115.

The ADC 120 converts an analog signal corresponding to the vocalizations of the user picked up by the microphone 17 into a digital signal. The digital signal obtained through this conversion is used in various processing operations executed by the CPU 111.

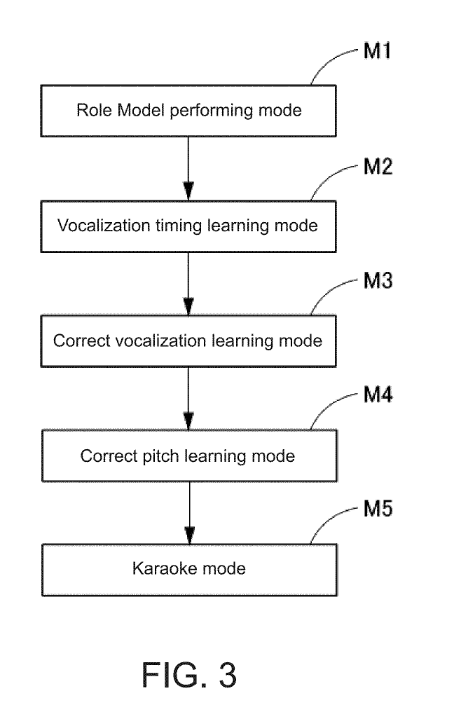

FIG. 3 is a diagram illustrating an example of modes that can be implemented by the singing practice device 1.

In FIG. 3, the modes that can be implemented by the singing practice device 1 include a role model performing mode M1, a vocalization timing learning mode M2, a correct vocalization learning mode M3, a correct vocalization & correct pitch learning mode M4 (hereafter, referred to as “correct pitch learning mode M4”), and a karaoke mode M5.

In the role model performing mode M1, digitally created role model singing sound (role model performing) is output from the speakers 18 with the correct vocalization timings, the correct lyrics, and the correct pitches together with an accompaniment. The term “correct” used in this specification is based on a standard set in the singing practice device 1 and does not mean “correct” in an absolute sense.

In the vocalization timing learning mode M2, only the accompaniment is output from the speakers 18. In the vocalization timing learning mode M2, the user can practice so as to become able to sing with the correct vocalization timings while listening to the accompaniment. The processing executed in the vocalization timing learning mode M2 will be described in detail later.

In the correct vocalization learning mode M3, only the accompaniment is output from the speakers 18. In the correct vocalization learning mode M3, the user can practice so as to become able to produce vocalizations with the correct vocalization timings and the correct lyrics while listening to the accompaniment. The processing executed in the correct vocalization learning mode M3 will be described in detail later.

In the correct pitch learning mode M4, only the accompaniment is output from the speakers 18. In the correct pitch learning mode M4, the user can practice so as to be become able to produce vocalizations with the correct vocalization timings, the correct lyrics, and the correct pitches while listening to the accompaniment. The processing executed in the correct pitch learning mode M4 will be described in detail later.

In the karaoke mode M5, only the accompaniment is output from the speakers 18. In the karaoke mode M5, the user sings while listening to the accompaniment as usual and is able to test the results of his/her practice. In addition, in the karaoke mode M5, the user's singing may be graded, and in this way, the user may be able to check the progress of his/her learning.

From the viewpoint of taking singing lessons, it is recommended that the user begin with the role model performing mode M1, and then proceed by practicing in the vocalization timing learning mode M2, the correct vocalization learning mode M3, and the correct pitch learning mode M4, until reaching the karaoke mode M5 (refer to arrows in FIG. 3). However, a configuration may be such that the user can select any of these modes anytime.

Here, it is assumed that the user will practice the lyrics of an existing musical piece, but a function for editing lyrics may be provided and the user may be allowed to practice the lyrics of a variation of a song created by the user. In the case of the education of young children, it can be anticipated that young children will show greater interest in original lyrics created by their mothers or the like. For example, pitch names may be memorized by singing the pitch names as lyrics, i.e., “do”, “re”, “mi”, “fa”, “sol”, “la”, “si”, and “do” in musical education aimed at young children. Therefore, a user may practice by singing the pitch names as lyrics.

In addition, as described above, in education of young children, the pitches of a musical piece may be memorized by singing the pitch names. In this embodiment, during a lesson using the optical keyboard 19, a user can learn the pitches of a musical piece by using the pitch names by being made to vocalize the pitch names instead of lyrics and by causing the corresponding keys of the optical keyboard 19 to flash or light up in the correct vocalization learning mode M3.

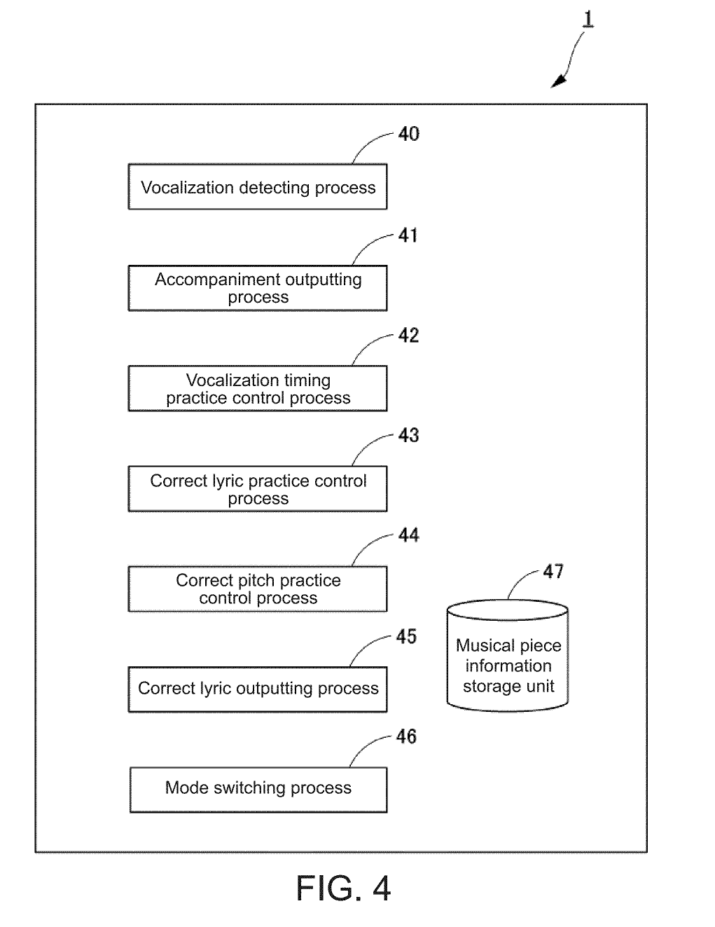

FIG. 4 is a block diagram illustrating an example of the functions of the singing practice device 1.

The singing practice device 1 includes the RAM 113, which temporarily stores instructions and/or data necessary for the CPU 111 and other processors, as the case may be, to perform a vocalization detecting process 40, an accompaniment outputting process 41, a vocalization timing practice control process 42, a correct lyric practice control process 43, a correct pitch practice control process 44, a correct lyric outputting process 45, and a mode switching process 46, and a musical piece information storage unit 47.

The vocalization detecting process 40, the accompaniment outputting process 41, the vocalization timing practice control process 42, the correct lyric practice control process 43, the correct pitch practice control process 44, the correct lyric outputting process 45, and the mode switching process 46 can be implemented by the CPU 111 executing one or more programs stored in a storage device such as the ROM 112. The musical piece information storage unit 47 can be implemented by a storage device such as the ROM 112. As a modification, the musical piece information storage unit 47 may be implemented by a writeable auxiliary storage device (not illustrated).

In the vocalization detecting process 40, vocalizations (utterances) of a user is detected on the basis of a digital signal (digital signal generated by ADC 120) acquired via the microphone 17. In addition, in the vocalization detecting process 40, non-voice sounds such as the sound of the microphone 17 being hit may also be detected, and only voice sounds of a person may be accepted by determining whether a sound is a sound of the voice of a person.

In the accompaniment outputting process 41, the accompaniment of a musical piece is output in accordance with musical piece data. The musical piece data includes accompaniment data for outputting the accompaniment, main melody data for outputting a main melody, and lyric data associated with the various notes of the main melody. The main melody data includes data relating to correct vocalization timings and data relating to correct pitches, and the lyric data includes data relating to correct lyrics. The musical piece data may be a standard MIDI file with lyrics (SMF with lyrics) that can include MIDI data and lyric data or may be a music XML file, which is a file format for transcribing a musical score. Of course, musical piece data having an original data format may be used.

In other words, accompaniment data and lyric data including data that represents first text (for example, “twin”) corresponding to a first timing in the accompaniment data (for example, t0 or interval from t0 to t1) and data representing second text (for example “kle”) corresponding to a second timing (t2) that is subsequent to the first timing is stored in the memory 112 or 113.

Here, the first text or the second text may be a single character corresponding to a certain note or may consist of a plurality of characters.

In addition, the first timing and the second timing may be pinpoint (for example, t0) timings or may have a fixed time width (for example, interval from t0 to t1).

The vocalization timing practice control process 42 determines whether the vocalization detecting process 40 has detected a vocalization that matches a vocalization timing according to the musical piece data (example of vocalization detection processing). The vocalization timing practice control process 42 includes a function of not allowing the accompaniment outputting process 41 to advance the accompaniment when a vocalization that matches a vocalization timing according to the musical piece data is not detected in the vocalization detecting process 40. “A vocalization timing according to the musical piece data” refers to a vocalization timing stipulated by data relating to correct vocalization timings included in the musical piece data. “A vocalization that matches a vocalization timing according to the musical piece data” refers to a vocalization that is detected within a prescribed allowed error with respect to one time point or a time range when a vocalization timing according to the musical piece data is stipulated at the one time point or time range. The prescribed allowed error may be varied in accordance with the tempo or the like of the musical piece, and may be customized by the user. The functions of the vocalization timing practice control process 42 will be described in detail later.

In other words, it is detected whether the user has produced a vocalization that matches the first timing, and in the case where a vocalization that matches the first timing is detected, the playback of the accompaniment data is allowed to advance from the first timing to a point immediately before the second timing, and in the case where a vocalization that matches the first timing is not detected, reproduction (automatic performance) of the accompaniment data is stopped.

The correct lyric practice control process 43 includes a function of not allowing the accompaniment outputting process 41 to advance the accompaniment when it is determined that a vocalization detected in the vocalization detecting process 40 as matching a vocalization timing according to the musical piece data does not match the correct lyric. Whether the vocalization matches the correct lyric may be determined in the following way, for example. Specifically, the vocalization detecting process 40 extracts a characteristic quantity of the vocalization, and the correct lyric practice control process 43 compares the characteristic quantity to the correct lyric using dynamic programming (DP) matching or a hidden Markov model and makes a determination. A characteristic quantity of a voice is a cepstrum parameter, for example. The functions of the correct lyric practice control process 43 will be described in detail later.

The correct pitch practice control process 44 includes a function of not allowing the accompaniment outputting process 41 to advance the accompaniment when it is determined that the pitch of a vocalization detected in the vocalization detecting process 40 as matching a vocalization timing according to the musical piece data does not match the correct pitch. The pitch can be extracted using the method disclosed in Japanese Patent No. 5246208, for example. The pitch of the vocalization does not have to strictly match the correct pitch and a certain error may be allowed. In other words, since the pitch of a person's voice varies somewhat, it is not necessary to make the determination using a precise pitch and it is sufficient that the pitch of the person's voice lies within a fixed allowed error range with respect to the correct pitch. This allowed error may customized by the user. The functions of the correct pitch practice control process 44 will be described in detail later.

The correct lyric outputting process 45 outputs correct lyrics synthesized in accordance with the musical piece data. For example, the correct lyric outputting process 45 outputs correct lyrics in cooperation with the singing voice sound source 119. The output timing of the correct lyrics will be described later.

The mode switching process 46 executes switching processing for switching the mode between the role model performing mode M1, the vocalization timing learning mode M2, the correct vocalization learning mode M3, the correct pitch learning mode M4, and the karaoke mode M5.

The mode switching process 46 may execute the switching processing in accordance with an instruction from the user or may execute the switching processing in accordance with prescribed rules, for example. For example, the mode switching process 46 may execute switching processing such that the user begins in the role model performing mode M1 and then proceeds by practicing in the vocalization timing learning mode M2, the correct vocalization learning mode M3, and the correct pitch learning mode M4 until reaching the karaoke mode M5. In either case, the user can practice in a mode that matches his/her own level, and therefore is able to take an effective singing lesson as described above. For example, in a lesson for learning a musical piece, a young child would be able to learn how to sing the musical piece including lyrics in a step by step manner.

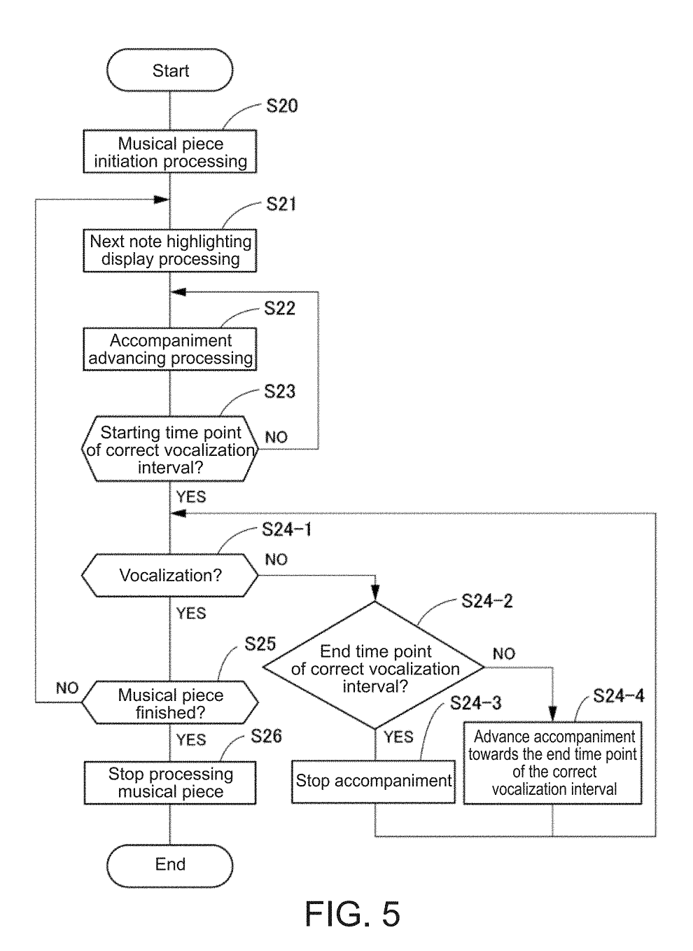

Next, an example of the processing operations performed in the vocalization timing learning mode M2, the correct vocalization learning mode M3, and the correct pitch learning mode M4 will be described while referring to FIG. 5 and figures thereafter.

FIG. 5 is an outline flowchart illustrating an example of processing executed by the singing practice device 1 in the vocalization timing learning mode M2.

In step S20, the accompaniment outputting process 41 acquires musical piece data relating to a specified musical piece from the musical piece information storage unit 47 and executes musical piece initiation processing. Specifically, the accompaniment outputting process 41 also executes processing for acquiring musical piece data related to the specified musical piece by reading the musical piece data from the ROM 112 into, for example, the RAM 113, which functions as a work area, in order to execute automatic accompaniment. The accompaniment outputting process 41 begins outputting the accompaniment of the musical piece in accordance with the musical piece data relating to the specified musical piece.

In step S21, the vocalization timing practice control process 42 executes next note highlighting display processing on the basis of the musical piece data. Specifically, the vocalization timing practice control process 42 outputs information representing the text of the next vocalization (lyric) via the display unit 15. For example, in FIG. 1, it is shown that the next vocalization is “twin” by highlighting the text “twin”.

In step S22, the accompaniment outputting process 41 executes accompaniment advancing processing (normal accompaniment advancing processing to next vocalization point) on the basis of the musical piece data. In other words, the accompaniment outputting process 41 makes the accompaniment advance at a normal tempo.

In step S23, the vocalization timing practice control process 42 determines whether the starting time point of a correct vocalization interval has arrived on the basis of the musical piece data. Here, as an example, a correct vocalization interval is an interval having a prescribed allowed error with respect to a vocalization timing (here, one time point) according to the musical piece data. In addition, as described above, the prescribed allowed error may be varied in accordance with the tempo or the like of the musical piece, and may be customized by the user. In the case where the determination result is “YES”, the processing advances to step S24-1, and otherwise, the processing returns to step S22.

In step S24-1, the vocalization timing practice control process 42 determines whether the vocalization detecting process 40 has detected a vocalization on the basis of a detection result of the vocalization detecting process 40. In the case where the determination result is “YES”, the processing advances to step S25, and otherwise, the processing advances to step S24-2. In other words, the CPU detects whether there is a vocalization that matches the first timing of the accompaniment data, and in the case where the CPU detects such a vocalization, the CPU allows reproduction of the accompaniment data to advance from the first timing to a point immediately before the second timing, and in the case where the CPU does not detect such a vocalization, the CPU stops reproduction of the accompaniment data.

In step S24-2, the vocalization timing practice control process 42 determines whether an end time point of a correct vocalization interval has arrived. In the case where the determination result is “YES”, the processing advances to step S24-3, and otherwise, the processing advances to step S24-4.

In step S24-3, the vocalization timing practice control process 42 makes the accompaniment outputting process 41 stop the accompaniment advancing processing. In addition, at this time, the accompaniment outputting process 41 may stop the accompaniment and enter a silent state or may intermittently output the sound of the accompaniment at an arbitrary time point within the correct vocalization interval (for example, at the end time point of the correct vocalization interval).

In step S24-4, the accompaniment outputting process 41 executes accompaniment advancing processing up to the end time point of the correct vocalization interval on the basis of the musical piece data.

Thus, when the determination result is “NO” in step S24-1, the processing enters a standby state of waiting until the vocalization detecting process 40 detects a vocalization while causing the accompaniment to advance in the correct vocalization interval. In this standby state, since the processing does not return to step S22, normal accompaniment advancing processing is not executed. Then, the vocalization timing practice control process 42 makes the accompaniment outputting process 41 stop advancing the accompaniment at the end time point of the correct vocalization interval (step S24-3) (example of accompaniment stopping processing and vocalization timing practice control processing) in the case where a vocalization is not detected up to the end time point of the correct vocalization interval (“YES” in step S24-2).

In step S25, the accompaniment outputting process 41 determines whether the musical piece has finished on the basis of the musical piece data. In the case where the determination result is “YES”, the processing advances to step S26, and otherwise, the processing returns to step S21.

In step S26, the accompaniment outputting process 41 executes musical piece stopping processing. In other words, advancement of the accompaniment ends normally.

According to the processing illustrated in FIG. 5, in the case where a vocalization that matches a vocalization timing according to the musical piece data is not detected in the vocalization detecting process 40, it can be ensured that the accompaniment advancing processing is not executed. Thus, the user is able to quickly realize when he/she has made a mistake in the vocalization timing from the fact that the accompaniment does not advance. On the other hand, when the accompaniment advances after the user has made a vocalization, the user can recognize that the vocalization timing was correct. Thus, the processing illustrated in FIG. 5 can effectively support the user in learning the correct vocalization timings.

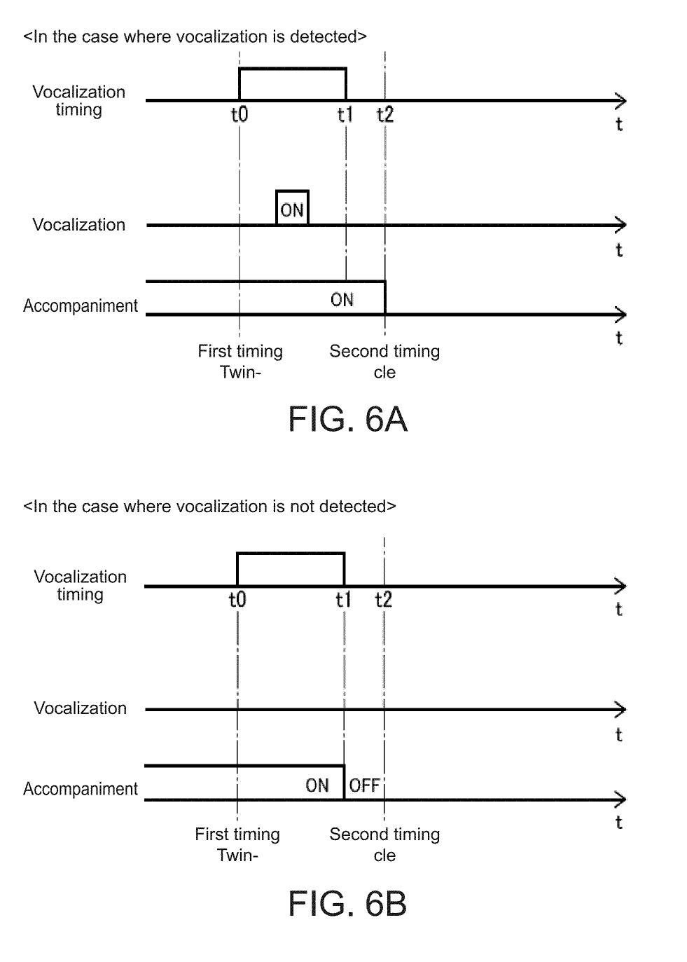

FIGS. 6A and 6B are explanatory diagrams for FIG. 5 and illustrate, in order from the top, examples of time sequences illustrating vocalization timings, vocalization detection results, and accompaniment advancement states. In FIGS. 6A and 6B, the vocalization timings are the same, and a correct vocalization interval from t0 to t1 (example of first timing) and the beginning timing t2 of the subsequent vocalization interval from t2 to t3 are illustrated. Regarding the vocalization detection results, “ON” represents a state in which a vocalization is detected. Regarding the accompaniment advancement states, “ON” represents a state in which the accompaniment is advancing, and “OFF” represents a state in which the accompaniment is stopped.

In the example illustrated in FIG. 6A, a vocalization is detected in the correct vocalization interval from t0 to t1, and therefore the accompaniment advances to the beginning t2 of the next correct vocalization interval (correct vocalization interval from t2 to t3). On the other hand, in the example illustrated in FIG. 6B, a vocalization is not detected in the correct vocalization interval from t0 to t1, and therefore in this case, the accompaniment is stopped.

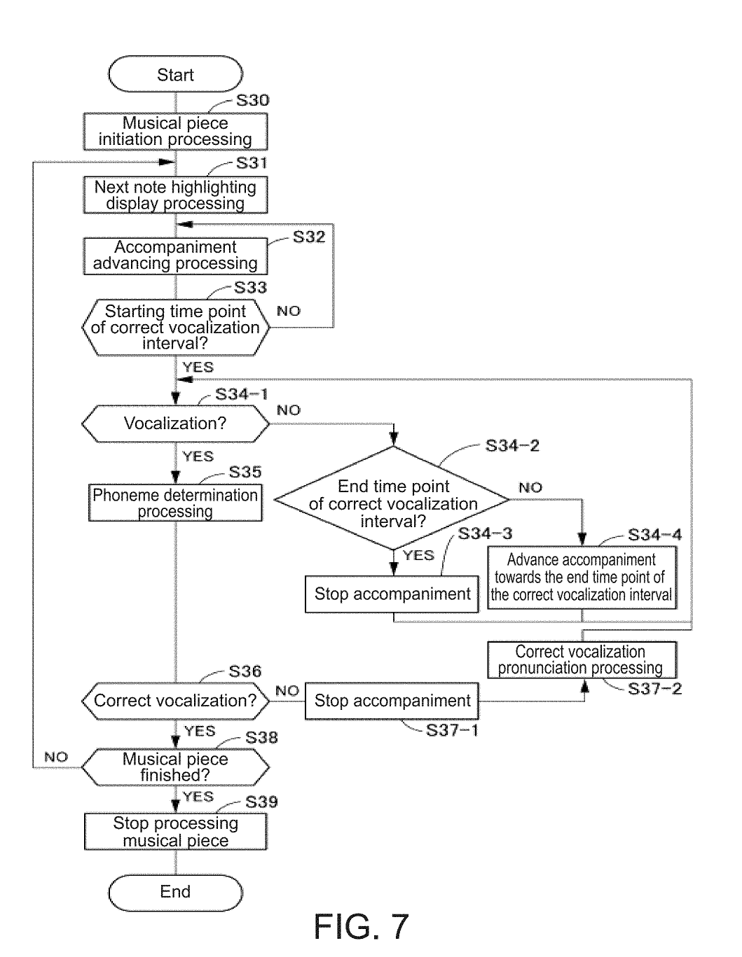

FIG. 7 is an outline flowchart illustrating an example of processing executed by the singing practice device 1 in the correct vocalization learning mode M3.

The content of the processing from step S30 to step S34-4 is the same as the content of the processing from step S20 to step S24-4 described above with reference to FIG. 5.

In step S34-1, in the case where the determination result is “YES”, the processing advances to step S35, and otherwise the processing enters a standby state of waiting until the vocalization detecting process 40 detects a vocalization.

In step S35, the correct lyric practice control process 43 executes phoneme determination processing for determining whether the vocalization matches the correct lyric. The method used to determine whether the vocalization matches the correct lyric is the same as that described above.

In step S36, in the case where the determination result of the phoneme determination processing of step S35 is “YES”, the processing advances to step S38. On the other hand, in the case where the determination result in the phoneme determination processing in step S35 is “NO”, the processing returns to step S34-1 via step S37-1 and step S37-2.

In step S37-1, the correct lyric outputting process 45 makes the accompaniment outputting process 41 stop the accompaniment advancing processing. In addition, at this time, the accompaniment outputting process 41 may stop the accompaniment and enter a silent state or may intermittently output the sound of the accompaniment at an arbitrary time point (for example, at the current time point) within the correct vocalization interval. Thus, in the case where it is determined that the vocalization does not match the correct lyric, the processing does not return to step S32, and therefore the accompaniment advancing processing is not executed. In other words, the correct lyric practice control process 43 does not allow the accompaniment outputting process 41 to advance the accompaniment (example of correct voice sound practice control processing).

In step S37-2, the correct lyric outputting process 45 performs correct vocalization pronunciation processing (example of singing voice vocalization processing). Specifically, in cooperation with the singing voice sound source 119, the correct lyric outputting process 45 outputs a correct lyric synthesized in accordance with the musical piece data via the speakers 18.

In step S38, the accompaniment outputting process 41 determines whether the musical piece has finished on the basis of the musical piece data. In the case where the determination result is “YES”, the processing advances to step S39, and otherwise, the processing returns to step S31.

In step S39, the accompaniment outputting process 41 executes musical piece stopping processing. In other words, advancement of the accompaniment ends normally.

According to the processing illustrated in FIG. 7, in the case where a vocalization that matches a vocalization timing according to the musical piece data is not detected in the vocalization detecting process 40, it can be ensured that the accompaniment advancing processing is not executed. Thus, the user is able to quickly realize when he/she has made a mistake in the vocalization timing from the fact that the accompaniment does not advance. On the other hand, when the accompaniment advances after the user has made a vocalization, the user can recognize that the vocalization timing was correct. Thus, the processing illustrated in FIG. 7 can effectively support the user in learning the correct vocalization timing.

In addition, according to the processing illustrated in FIG. 7, even in the case where some sort of vocalization that matches a vocalization timing according to the musical piece data is detected in the vocalization detecting process 40, it can be ensured that the accompaniment advancing processing is not executed when it is determined that the vocalization does not match the correct lyric. Thus, the user is able to quickly realize when he/she has made an incorrect vocalization from the fact that the accompaniment does not advance. On the other hand, when the accompaniment advances after the user has made a vocalization, the user can recognize that the vocalization (lyric) was correct. Thus, the processing illustrated in FIG. 7 can effectively support the user in learning correct lyrics.

In addition, according to the processing illustrated in FIG. 7, when it is determined that the vocalization does not match the correct lyric, the correct lyric synthesized in accordance with the musical piece data is output. Thus, as well as being able to quickly realize when he/she has made an incorrect vocalization (lyric), the user is able to easily learn the correct lyric.

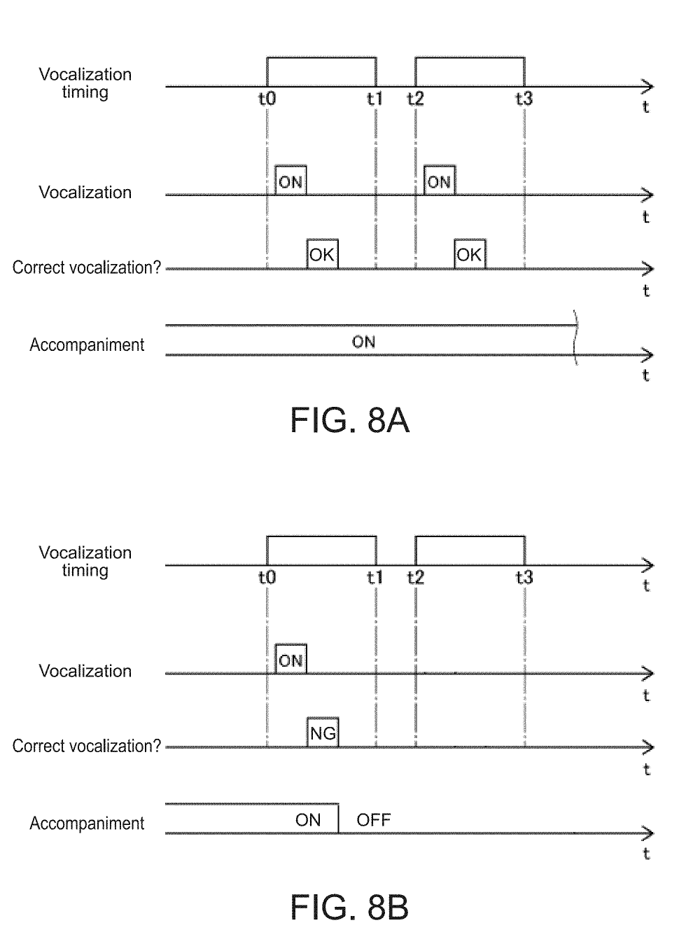

FIGS. 8A and 8B are explanatory diagrams for FIG. 7 and illustrate, in order from the top, examples of time sequences illustrating vocalization timings, vocalization detection results, determination results of whether the vocalization of a user matches a correct lyric, and accompaniment advancement states. In FIGS. 8A and 8B, the vocalization timings are the same, and a correct vocalization interval from t0 to t1 (example of first timing) and a correct vocalization interval from t2 to t3 (example of second timing) are illustrated. Regarding the vocalization detection results, “ON” represents a state in which a vocalization is detected. Regarding the accompaniment advancement states, “ON” represents a state in which the accompaniment is advancing, and “OFF” represents a state in which the accompaniment is stopped. In addition, regarding the determination results of whether a vocalization of a user matches the correct lyric, “OK” represents a determination result obtained when the vocalization of the user matches the correct lyric and “NG” represents a determination result obtained when the vocalization of the user does not match the correct lyric.

In the example illustrated in FIG. 8A, a vocalization is detected in the correct vocalization interval from t0 to t1 and it is determined that the vocalization matches the correct lyric (example of first text). Therefore, the accompaniment advances to the next correct vocalization interval (correct vocalization interval from t2 to t3). In addition, a vocalization is detected in the correct vocalization interval from t2 to t3 and it is determined that the vocalization matches the correct lyric (example of second text). Therefore, the accompaniment advances to the next correct vocalization interval (not illustrated). On the other hand, in the example illustrated in FIG. 8B, a vocalization is detected in the correct vocalization interval from t0 to t1, but it is determined that the vocalization does not match the correct lyric. Therefore, in this case, the accompaniment is stopped.

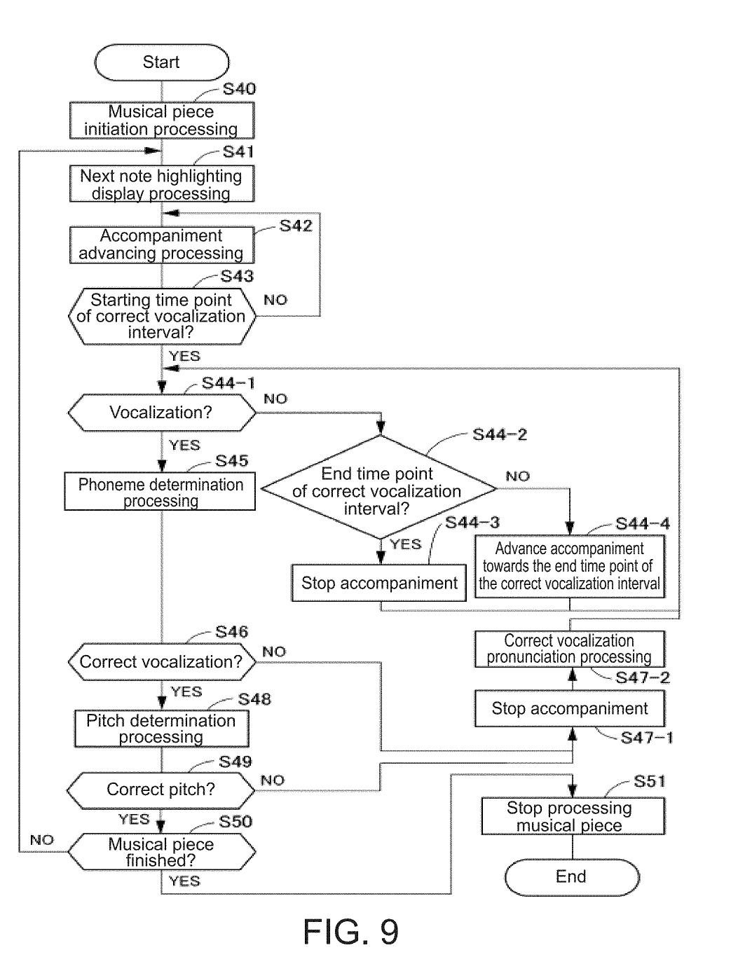

FIG. 9 is an outline flowchart illustrating an example of processing executed by the singing practice device 1 in the correct pitch learning mode M4.

The content of the processing from step S40 to step S44-4 is the same as the content of the processing from step S20 to step S24-4 described above with reference to FIG. 5. In addition, the content of the processing from step S45 to step S47-2 is the same as the content of the processing from step S35 to step S37-2 described above with reference to FIG. 7.

In step S46, in the case where the determination result is “YES” in the phoneme determination processing, the processing advances to step S48.

In step S48, the correct pitch practice control process 44 executes pitch determination processing. Specifically, the correct pitch practice control process 44 determines whether the pitch of the vocalization detected in the vocalization detecting process 40 matches the correct pitch. For example, in the example in FIG. 1, it is determined that the user vocalized the pitch “G”.

In step S49, in the case where the determination result of the pitch determination processing of step S48 is “YES”, the processing advances to step S50. On the other hand, in the case where the determination result of the pitch determination processing of step S48 is “NO”, the processing returns to step S44-1 via step S47-1 and step S47-2. Therefore, in the case where it is determined that the pitch of the vocalization does not match the correct pitch, the processing does not return to step S42, and therefore the accompaniment advancing processing is not executed. In other words, the correct pitch practice control process 44 does not allow the accompaniment outputting process 41 to advance the accompaniment (example of correct pitch practice control processing).

In addition, in step S49, the correct pitch practice control process 44 may make the lamp 160 corresponding to the pitch of the vocalization detected in the vocalization detecting process 40 among the plurality of lamps 160 of the guidance unit 16 light up. In other words, the correct pitch practice control process 44 may display information indicating whether the pitch of the vocalization is higher or lower than the correct pitch via the guidance unit 16. Thus, the user can be shown whether the pitch of the vocalization made by the user is identical to the correct pitch, lower than the correct pitch, or higher than the correct pitch.

In step S50, the correct pitch practice control process 44 determines whether the musical piece has finished on the basis of the musical piece data. In the case where the determination result is “YES”, the processing advances to step S51, and otherwise, the processing returns to step S41.

In step S51, the accompaniment outputting process 41 executes musical piece stopping processing. In other words, advancement of the accompaniment ends normally.

According to the processing illustrated in FIG. 9, in the case where a vocalization that matches a vocalization timing according to the musical piece data is not detected in the vocalization detecting process 40, it can be ensured that the accompaniment advancing processing is not executed. Thus, the user is able to quickly realize when he/she has made a mistake in the vocalization timing from the fact that the accompaniment does not advance. On the other hand, when the accompaniment advances after the user has made a vocalization, the user can recognize that the vocalization timing was correct. Thus, the processing illustrated in FIG. 9 can effectively support the user in learning the correct vocalization timing.

In addition, according to the processing illustrated in FIG. 9, even in the case where some sort of vocalization that matches a vocalization timing according to the musical piece data has been detected in the vocalization detecting process 40, it can be ensured that the accompaniment advancing processing is not executed when it is determined that the vocalization does not match the correct lyric or when it is determined that the pitch of the vocalization does not match the correct pitch. Thus, the user is able to quickly realize when he/she has made an incorrect vocalization or a vocalization with an incorrect pitch from the fact that the accompaniment does not advance. On the other hand, when the accompaniment advances after the user has made a vocalization, the user can recognize that the vocalization and pitch were correct. Thus, the processing illustrated in FIG. 9 can effectively support the user in learning correct lyrics and correct pitch.

In addition, according to the processing illustrated in FIG. 9, when it is determined that the vocalization does not match the correct lyric or when it is determined that the pitch of the vocalization does not match the correct pitch, the correct singing sound synthesized in accordance with the musical piece data is output. Thus, the user is able to quickly realize when he/she has made an incorrect vocalization or a vocalization with an incorrect pitch, and can easily learn the correct lyric or pitch.

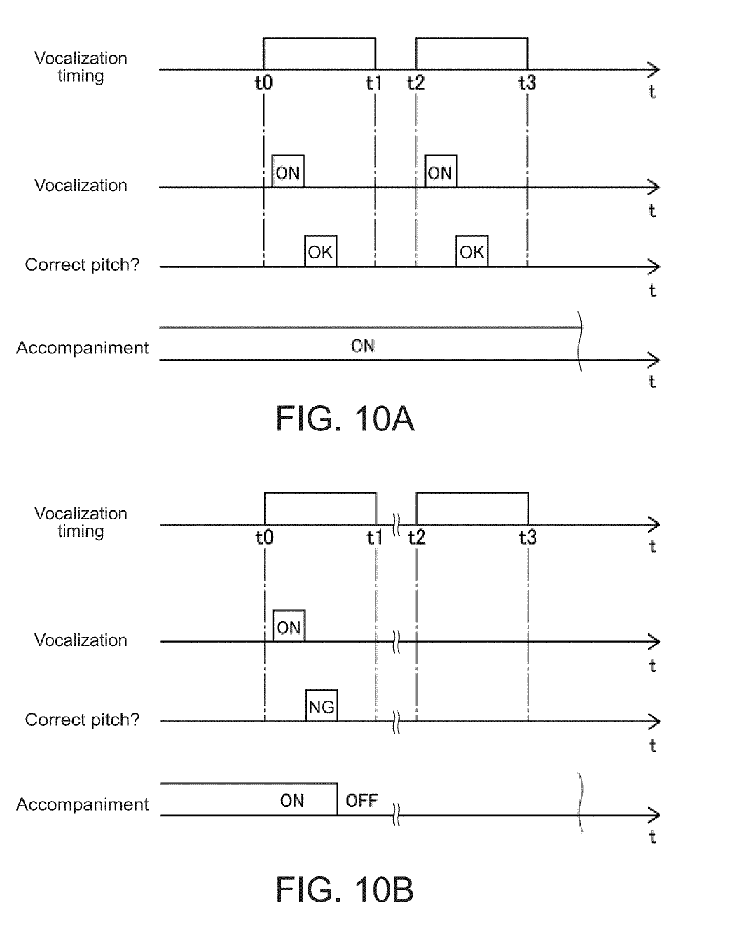

FIGS. 10A and 10B are explanatory diagrams for FIG. 9 and illustrate, in order from the top, examples of time sequences illustrating vocalization timings, vocalization detection results, determination results of whether the pitch of a vocalization of a user matches a correct pitch, and accompaniment advancement states. In FIGS. 10A and 10B, the vocalization timings are the same, and a correct vocalization interval from t0 to t1 (example of first timing) and a correct vocalization interval from t2 to t3 (example of second timing) are illustrated. Regarding the vocalization detection results, “ON” represents a state in which a vocalization is detected. Regarding the accompaniment advancement states, “ON” represents a state in which the accompaniment is advancing, and “OFF” represents a state in which the accompaniment is stopped. In addition, regarding the determination results of whether the pitch of a vocalization of the user matches the correct pitch, “OK” represents a determination result obtained when the pitch of the vocalization of the user matches the correct pitch and “NG” represents a determination result obtained when the pitch of the vocalization of the user does not match the correct pitch. Although not illustrated in FIGS. 10A and 10B, it is assumed that it is determined that each vocalization matches the correct lyric.

In the example illustrated in FIG. 10A, a vocalization is detected in the correct vocalization interval from t0 to t1, and it is determined that the pitch of the vocalization matches the correct pitch (example of first pitch). Therefore, the accompaniment advances to the next correct vocalization interval (correct vocalization interval from t2 to t3). In addition, a vocalization is detected in the correct vocalization interval from t2 to t3, and it is determined that the pitch of the vocalization matches the correct pitch (example of second pitch). Therefore, the accompaniment advances to the next correct vocalization interval (not illustrated). On the other hand, in the example illustrated in FIG. 10B, a vocalization is detected in the correct vocalization interval from t0 to t1, but it is determined that the pitch of the vocalization does not match the correct pitch. Therefore, in this case, the accompaniment is stopped.

Incidentally, in the related art, an electronic keyboard that has a lesson function for young children or beginners of a musical instrument is known. For example, in a lesson using an electronic keyboard having an optical keyboard, the keys that should be pressed in order as a musical piece progresses, are made to flash or light up, and when the user presses a key, the musical piece advances to the next note.

However, regarding singing, which may be described as playing the most fundamental musical instrument, there are no electronic musical instruments having a lesson function for supporting young children in learning how to sing a musical piece including lyrics. Although some karaoke machines have a function for grading a user's singing, this is a function for grading the singing of a song that the user has already learned rather than a lesson function and this is not suitable for the purpose of supporting a young child in memorizing the lyrics of a musical piece, memorizing the melody of the musical piece, and so on.

Regarding this point, according to this embodiment, a young child is able to learn how to sing a musical piece including lyrics with the same ease of understanding and convenience as in the case where a young child learns how to play a musical piece using an electronic keyboard instrument.

Embodiments have been described in detail above, but the present invention is not limited to those specific embodiments, and various modifications and changes can be made within the scope defined by the claims. In addition, all or a plurality of the constituent elements in the above-described embodiments may be combined with each other.

For example, in the above-described embodiment, the correct vocalization learning mode M3 and the correct pitch learning mode M4 are provided as learning modes in addition to the vocalization timing learning mode M2, but the present invention is not limited to this example. For example, just one out of the correct vocalization learning mode M3 and the correct pitch learning mode M4 may be provided in addition to the vocalization timing learning mode M2.

Furthermore, a correct pitch learning mode may be provided instead of or in addition to the correct vocalization learning mode M3 in the above-described embodiment. In this case, step S45 and step S46 in FIG. 9 would be omitted.

As another embodiment, a sound piece in one beat may be determined every one beat or a syllable or syllables in one musical bar may be determined every musical bar. It is sufficient that the CPU 111 determine the presence/absence of a vocalization made by the user and determine whether the vocalization made by the user is correct every time length (certain section) defined by a certain length of time.

Specific embodiments of the present invention have been described above, but the present invention is not limited to the above-described embodiments and various changes may be made without departing from the gist of the present invention. It will be apparent to a person skilled in the art that various changes and modifications can be made to the present invention without departing from the spirit or the scope of the present invention. Therefore, it is intended that the present invention encompass the scope of the appended claims and alterations and modifications that come within the scope of the appended claims. In particular, it is explicitly intended that a combination of any two or more out of the above-described embodiments and modifications of the embodiment partly or entirely combined with each other can be considered as being within the scope of the present invention.

It will be apparent to those skilled in the art that various modifications and variations can be made in the present invention without departing from the spirit or scope of the invention. Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention.

What is claimed is:

1. A singing practice device comprising:
a memory having stored thereon a musical piece data of a musical piece that includes accompaniment data for an accompaniment and vocal data for a vocal part to be sung by a user, the vocal part including at least a first segment to be sung by the user during a first time interval while the accompaniment is being played back and a second segment to be sung by the user during a second time interval that follows the first time interval while the accompaniment is being played back;
at least one processor;
an audio input device to receive vocal input by the user; and
an audio output device to audibly output sound to the user,
wherein the at least one processor performs the following:
causing the accompaniment to be played back from the audio output device in accordance with the accompaniment data;
when the first time interval arrives while the accompaniment is being played back, determining whether an utterance is input by the user through the audio input device during the first time interval;
causing the accompaniment to continue being played back until a point in time immediately before the second time interval only when the utterance was input by the user during the first time interval; and
causing the accompaniment to stop being played back when the utterance was not input by the user during the first time interval.

2. The singing practice device according to claim 1,
wherein the first and second segments of the vocal part include first and second letters, respectively, to be pronounced by the user when the user is uttering the first and second segments, respectively, and
wherein when the at least one processor has determined that the utterance was input by the user through the audio input device during the first time interval, the at least one processor executes a phoneme determination process to analyze a letter of the utterance by the user, and causes the accompaniment to continue being played back until the point in time immediately before the second time interval when the letter of the utterance matches the first letter.

3. The singing practice device according to claim 2,
wherein when the at least one processor has determined that the utterance was input by the user through the audio input device during the first time interval and that the letter of the utterance did not match the first letter, the at least one processor causes the accompaniment to stop being played back and causes a correct vocal sound corresponding to the first segment with the first letter to be synthesized and output from the audio output device.

4. The singing practice device according to claim 1,
wherein the first and second segments of the vocal part include first and second pitches, respectively, to be generated by the user when the user is uttering the first and second segments, respectively, and
wherein when the at least one processor has determined that the utterance was input by the user through the audio input device during the first time interval, the at least one processor executes a pitch determination process to analyze a pitch of the utterance by the user, and causes the accompaniment to continue being played back until the point in time immediately before the second time interval when the pitch of the utterance matches the first pitch.

5. The singing practice device according to claim 4,
wherein when the at least one processor has determined that the utterance was input by the user through the audio input device during the first time interval and that the pitch of the utterance did not match the first pitch, the at least one processor causes the accompaniment to stop being played back and causes a correct vocal sound corresponding to the first segment with the first pitch to be synthesized and output from the audio output device.

6. The singing practice device according to claim 4,
wherein when the at least one processor has determined that the utterance was input by the user through the audio input device during the first time interval, the at least one processor causes a deviation of the analyzed pitch of the utterance by the user from the first pitch to be communicated to the user.

7. The singing practice device according to claim 1,
wherein the first and second segments of the vocal part include first and second letters, respectively, and first and second pitches, respectively, to be generated by the user when the user is uttering the first and second segments, respectively, and
wherein when the at least one processor has determined that the utterance was input by the user through the audio input device during the first time interval, the at least one processor causes the accompaniment to stop being played back if at least one of the following two conditions is met:
i) a letter indicated by the utterance of the user during the first time interval does not match the first letter, and
ii) a pitch indicated by the utterance of the user during the first time interval does not match the first pitch.

8. A method to be executed by at least one processor in a singing practice device that includes: a memory having stored thereon a musical piece data of a musical piece that includes accompaniment data for an accompaniment and vocal data for a vocal part to be sung by a user, the vocal part including at least a first segment to be sung by the user during a first time interval while the accompaniment is being played back and a second segment to be sung by the user during a second time interval that follows the first time interval while the accompaniment is being played back; at least one processor; an audio input device to receive vocal input by the user; and an audio output device to audibly output sound to the user, method comprising, via the at least one processor:
causing the accompaniment to be played back from the audio output device in accordance with the accompaniment data;
when the first time interval arrives while the accompaniment is being played back, determining whether an utterance is input by the user through the audio input device during the first time interval;
causing the accompaniment to continue being played back until a point in time immediately before the second time interval only when the utterance is input by the user during the first time interval; and
causing the accompaniment to stop being played back when the utterance was not input by the user during the first time interval.

9. A non-transitory computer-readable storage medium having stored thereon a program executable by at least one processor in a singing practice device that includes, in addition to the at least one processor: a memory having stored thereon a musical piece data of a musical piece that includes accompaniment data for an accompaniment and vocal data for a vocal part to be sung by a user, the vocal part including at least a first segment to be sung by the user during a first time interval while the accompaniment is being played back and a second segment to be sung by the user during a second time interval that follows the first time interval while the accompaniment is being played back; an audio input device to receive vocal input by the user; and an audio output device to audibly output sound to the user, method comprising, via the at least one processor, the program causing the at least one processor to perform the following:
causing the accompaniment to be played back from the audio output device in accordance with the accompaniment data;
when the first time interval arrives while the accompaniment is being played back, determining whether an utterance is input by the user through the audio input device during the first time interval;
causing the accompaniment to continue being played back until a point in time immediately before the second time interval only when the utterance is input by the user during the first time interval; and
causing the accompaniment to stop being played back when the utterance was not input by the user during the first time interval.
